(19) United States
(12) Patent Application Publication
(10) Pub. No.: US 2013/0214628 A1
(43) Pub. Date: Aug. 22, 2013

(54) WIND TURBINE GENERATORS

(71) Applicants: Graham Le Flem, Warwickshire (GB); Ian Benjamin Wise, Warwickshire (GB); Joseph Eugene, Warwickshire (GB); John Frederick Hill, Warwickshire (GB)

(72) Inventors: Graham Le Flem, Warwickshire (GB); Ian Benjamin Wise, Warwickshire (GB); Joseph Eugene, Warwickshire (GB); John Frederick Hill, Warwickshire (GB)

(73) Assignee: GE ENERGY POWER CONVERSION TECHNOLOGY LTD., Warwickshire (GB)

(21) Appl. No.: 13/810,238

(22) PCT Filed: Jul. 27, 2010
(86) PCT No.: PCT/EP2010/004574

§ 371 Date: Mar. 22, 2013

(51) Int. Cl. H02K 7/08

(52) U.S. Cl. CPC H02K 7/083
USPC 310/90

(57) ABSTRACT

A wind turbine generator has a drive end at which one or more turbine blades are mountable and a non-drive end. The wind turbine generator comprises an external stator having a radially inner surface and an internal rotor having a radially outer surface, an air gap being defined between the rotor and the stator. A main bearing arrangement is provided at the drive end and acts between the rotor and the stator to mount the rotor for rotation about the stator and a stabiliser beating is provided at the non-drive end and acts between the rotor and the stator to stabilise the rotor and stator and maintain and control the air gap therebetween.

### FIELD OF THE INVENTION

The present invention relates generally to wind turbine generators. Embodiments of the present invention relate in particular to a wind turbine generator in which the rotor and the stator are stabilised to maintain and control the air gap between the rotor and the stator.

### BACKGROUND TO THE INVENTION

Wind turbines are typically large diameter, high torque low speed electrical machines and include a wind turbine generator having a rotor and stator. The air gap between the rotor and stator of the wind turbine generator is particularly small compared to the diameter of the rotor. For example, the rotor may have a diameter of the order of several metres or more whilst the air gap between the rotor and the stator may only be a few millimetres.

Turbine blades are typically mounted on a turbine shaft of the wind turbine and deflections of the turbine shaft can arise as a result of transient loading caused by gusts of wind. These deflections can be transmitted to the rotor and if the movements of the rotor and stator are not coordinated, the air gap between the rotor and the stator can be adversely affected. This can reduce the efficiency of the wind turbine generator by compromising the passage of magnetic flux through the air gap. Due to the small size of the air gap, contact between the rotor and stator can arise if there is significant deflection of the rotor. A significant amount of structural reinforcement is, therefore, normally needed to maintain the air gap and this increases the structural complexity, mass and cost of the wind turbine generator.

There is, therefore, a need for a wind turbine generator in which the rotor and stator can be stabilised to provide air gap control and which is structurally less complex than known wind turbine generators.

### SUMMARY OF THE INVENTION

According to a first aspect of the present invention, there is provided a wind turbine generator having a drive end at which one or more turbine blades are mountable and a non-drive end, the wind turbine generator comprising:
a first substantially cylindrical hollow body having a radially inner surface;
a second substantially cylindrical hollow body located within the first substantially cylindrical hollow body and having a radially outer surface;
   one of the first substantially cylindrical hollow body and the second substantially cylindrical hollow body being a rotor;
   the other of the first substantially cylindrical hollow body and the second substantially cylindrical hollow body being a stator, an air gap being defined between the rotor and the stator;
a main bearing arrangement at the drive end acting between the rotor and the stator to mount the rotor for rotation about the stator;
a stabiliser bearing at the non-drive end acting between the rotor and the stator to stabilise the rotor and stator and maintain the air gap therebetween.

The primary radial and axial loads, namely yaw, pitch and thrust loads, are carried by the main bearing arrangement at the drive end of the wind turbine generator and are transmitted by the main bearing arrangement to the stator. As a result, the stabiliser bearing does not carry significant loads. The stabiliser bearing is, therefore, a standard and relatively inexpensive ‘off-the-shelf’ bearing. Because the rotor and stator are in the form of hollow bodies which do not require structural reinforcement to maintain the rotor-stator air gap, the wind turbine generator is lighter and structurally less complex than existing wind turbine generators, thus reducing the cost of the wind turbine generator. In addition to maintaining and controlling the air gap between the rotor and the stator, the stabiliser bearing may remove resonances and oscillations which can be present in certain configurations of the wind turbine generator, thereby further stabilising the wind turbine generator.

According to second aspect of the present invention, there is provided a wind turbine including a wind turbine generator according to the first aspect of the present invention and a hub carrying one or more turbine blades mounted on the rotor at the drive end of the wind turbine generator.

The wind turbine typically includes a tower on which the wind turbine generator is mounted.

The first substantially cylindrical hollow body may include a first cylindrical support member which may be located at the non-drive end. The second substantially cylindrical hollow body may include a second cylindrical support member which may be located at the non-drive end. The stabiliser bearing normally acts between the first and second cylindrical support members at the non-drive end of the wind turbine generator to stabilise the rotor and the stator and thereby maintain and control the air gap therebetween.

The rotor has an axis of rotation about which it rotates and the first and second cylindrical support members are typically arranged about the same axis of rotation as the rotor.

The first and second cylindrical support members may be arranged coaxially with respect to each other, with the second cylindrical support member normally being located radially inwardly of the first cylindrical support member.

The diameter of the first cylindrical support member may be significantly less than the diameter of the first substantially cylindrical hollow body. The diameter of the second cylindrical support member may be significantly less than the diameter of the second substantially cylindrical hollow body. Accordingly, the stabiliser bearing, which acts between the first and second cylindrical support members, has a relatively small diameter which further enables a standard, off-the-shelf, bearing to be used.

The wind turbine generator may include a first mounting arrangement for mounting the first cylindrical support member on the first substantially cylindrical hollow body and may include a second mounting arrangement for mounting the second cylindrical support member on the second substantially cylindrical hollow body

In one embodiment, at least one of the first and second mounting arrangements comprises a mounting plate. More typically, each of the first and second mounting arrangements comprises a mounting plate. The mounting plate offers a particularly rigid solution for mounting the or each of the first and/or second cylindrical support members.

In another embodiment, at least one of the first and second mounting arrangements comprises a plurality of circumferentially spaced and radially extending spoke members. More typically, each of the first and second mounting arrangements comprises a plurality of circumferentially spaced and radially extending spoke members. The spoke members offer a particularly lightweight solution for mounting the or each of the first and/or second cylindrical support members.

Possibly, one of the first and second mounting arrangements may comprise a mounting plate and the other of the first and second mounting arrangements may comprise a plurality of circumferentially spaced and radially extending spoke members.

The first substantially cylindrical hollow body may include a first support flange at the drive end of the wind turbine generator. The second substantially cylindrical hollow body may include a second support flange at the drive end of the wind turbine generator. The main bearing arrangement may act between the first and second support flanges to mount the rotor for rotation about the stator.

The main bearing arrangement may include an outer bearing ring which may cooperate with the first support flange and may include at least one inner bearing ring which may cooperate with the second support flange. The main bearing arrangement may be a tapered roller bearing and more typically a double-row tapered roller bearing. The main bearing arrangement may, for example, include two inner bearing rings. A first row of tapered rollers may cooperate with a first inner bearing ring and a first raceway provided on the outer bearing ring and a second row of tapered rollers may cooperate with a second inner bearing ring and a second raceway provided on the outer bearing ring. The use of a double-row tapered roller bearing, especially having two inner bearing rings and a single outer bearing ring, is advantageous as it enables the main bearing arrangement to carry the primary radial and axial loads that arise during operation of the wind turbine.

The first body may have one of a plurality of circumferentially spaced winding slots and a plurality of circumferentially spaced magnet poles formed at its radially inner surface. The second body may, thus, have the other of the plurality of circumferentially spaced winding slots and the plurality of circumferentially spaced magnet poles formed at its radially outer surface

In typical embodiments, the first body is the stator and the second body is the rotor. The rotor may, thus, be rotatably mounted inside the stator. In alternative embodiments, the first body is the rotor and the second body is the stator. The rotor may, thus, be rotatably mounted outside the stator.

### BRIEF DESCRIPTION OF THE DRAWINGS

FIG. 1 is a diagrammatic perspective cutaway view of one embodiment of a wind turbine generator according to the present invention; and

FIG. 2 is a diagrammatic perspective cutaway view of another embodiment of a wind turbine generator according to the present invention.

### DETAILED DESCRIPTION OF EMBODIMENTS OF THE INVENTION

Embodiments of the present invention will now be described by way of example only and with reference to the accompanying drawings.

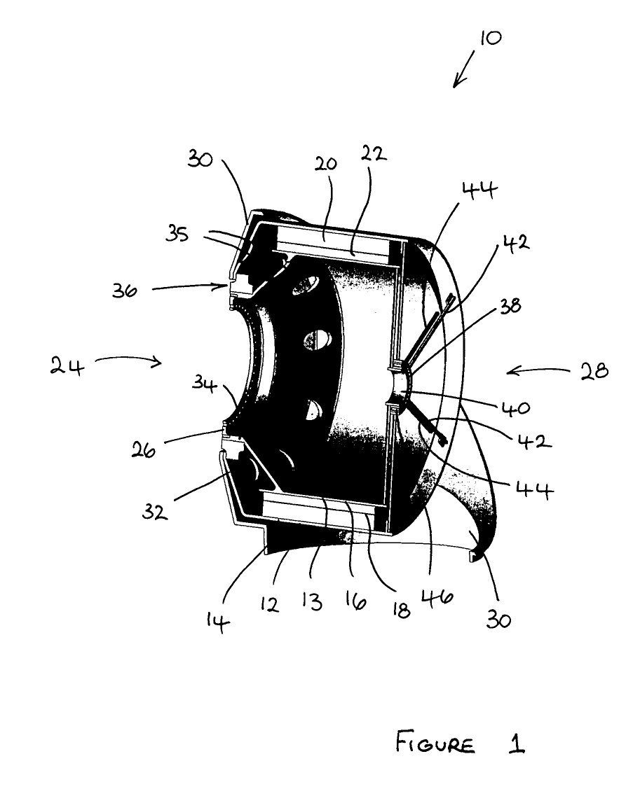

Referring initially to FIG. 1, a wind turbine generator 10 comprises a first body 12 in the form of an external stator 14 and a second body 13 in the form of an internal rotor 16. An air gap 18 is defined between the rotor 16 and the stator 14 in a conventional manner and the stator 14 includes a plurality of circumferentially spaced winding slots 20 whilst the rotor 16 includes a plurality of circumferentially spaced permanent magnets 22 forming permanent magnet poles.

The wind turbine generator 10 includes a drive end 24 at which turbine blades (not shown) are mounted on the rotor 16 by a hub (not shown) which can be secured to rotor hub flange 26. The wind turbine generator 10 also includes a non-drive end 28 which is axially spaced from the drive end 24. The wind turbine generator 10 forms part of a wind turbine including a tower and the wind turbine includes a nacelle 30 (only part of which is shown in FIG. 1) which is mounted at the top of the tower and to which the stator 14 of the wind turbine generator 10 is rigidly connected.

The stator 14 includes a first support flange 32 at the drive end 24 of the wind turbine generator 10 and the rotor 16 likewise includes a second support flange 34 at the drive end 24. The first and second support flanges 32, 34 are inclined towards the axis of rotation of the rotor 16 and a main bearing arrangement 36 acts between the first and second support flanges 32, 34 to rotatably mount the rotor 16 relative to the stator 14. Each of the first and second support flanges 32, 34 includes a plurality of circumferentially spaced cooling apertures 35 to permit the flow of cooling air through the wind turbine generator 10. The main bearing arrangement 36 typically comprises a double-row tapered roller bearing which carries the radial and axial loads generated during operation of the wind turbine.

The stator 14 and rotor 16 respectively include first and second cylindrical support members 38, 40 at the non-drive end 28 of the wind turbine generator 10. The first and second cylindrical support members 38, 40 are coaxial and are arranged about the axis of rotation of the rotor 16. It will be readily appreciated from FIG. 1 that the diameter of the first cylindrical support member 38 is significantly less than the diameter of the stator 14 and likewise that the diameter of the second cylindrical support member 40 is significantly less than the diameter of the rotor 16.

In the embodiment illustrated in FIG. 1, the first cylindrical support member 38 is mounted on the stator 14 via a first mounting arrangement comprising a plurality of circumferentially spaced and radially extending spoke members 42. In a similar way, the second cylindrical support member 40 is mounted on the rotor 16 via a second mounting arrangement comprising a plurality of circumferentially spaced and radially extending spoke members 44.

The wind turbine generator 10 includes a stabiliser bearing 46 which is located at the non-drive end 28 and which acts between the first and second cylindrical support members 38, 40. The stabiliser bearing 46 is typically a roller bearing having a single row of rollers and stabilises the movement of the stator 14 and the rotor 16, thereby controlling and maintaining the rotor-stator air gap 18 in a simple yet very effective manner. Because the radial and axial loads generated during operation of the wind turbine are carried by the main bearing arrangement 36, the stabiliser bearing 46 does not carry any significant operational loads.

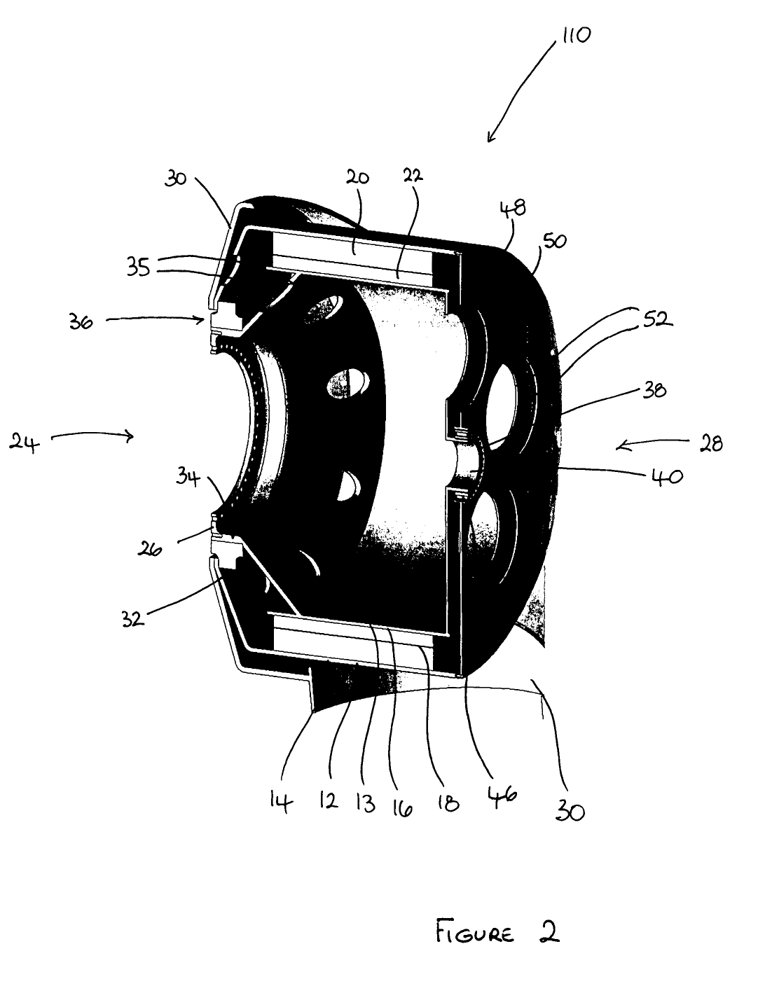

Referring now to FIG. 2, there is shown an alternative embodiment of a wind turbine generator 110 in accordance with the present invention. The wind turbine generator 110 is similar to the wind turbine generator 10 described above and illustrated in FIG. 1, and corresponding reference numerals are, therefore, used to identify corresponding components.

The wind turbine generator 110 employs a modified structure for mounting the first and second cylindrical support members 38, 40 on the stator 14 and rotor 16 respectively. More specifically, a first mounting arrangement in the form of a first generally circular mounting plate 48 mounts the first cylindrical support member 38 on the stator 14 whilst a second mounting arrangement in the form of a second generally circular mounting plate 50 mounts the second cylindrical support member 40 on the rotor 16. In order to permit cooling air to flow through the wind turbine generator 10, each of the first and second mounting plates 48, 50 includes a plurality of circumferentially spaced cooling apertures 52.

Although embodiments of the invention have been described in the preceding paragraphs with reference to various examples, it should be understood that various modifications may be made to those examples without departing from the scope of the present invention, as claimed.

What is claimed is:

1. A wind turbine generator having a drive end at which one or more turbine blades are mountable and a non-drive end, the wind turbine generator comprising:
a first substantially cylindrical hollow body having a radially inner surface;
a second substantially cylindrical hollow body located within the first substantially cylindrical hollow body and having a radially outer surface;
one of the first substantially cylindrical hollow body and the second substantially cylindrical hollow body being a rotor;
the other of the first substantially cylindrical hollow body and the second substantially cylindrical hollow body being a stator, an air gap being defined between the rotor and the stator;
a main bearing arrangement at the drive end acting between the rotor and the stator to mount the rotor for rotation about the stator;
a stabiliser bearing at the non-drive end acting between the rotor and the stator to stabilise the rotor and stator and maintain the air gap therebetween.

2. The wind turbine generator of claim 1, wherein the first substantially cylindrical hollow body includes a first cylindrical support member located at the non-drive end and the second substantially cylindrical hollow body includes a second cylindrical support member located at the non-drive end, the stabiliser bearing acting between the first and second cylindrical support members.

3. The wind turbine generator of claim 2, wherein the first and second cylindrical support members are arranged about the axis of rotation of the rotor.

4. The wind turbine generator of claim 2, wherein the first and second cylindrical support members are coaxial, the second cylindrical support member being located radially inwardly of the first cylindrical support member.

5. The wind turbine generator claim 2, wherein the diameter of the first cylindrical support member is significantly less than the diameter of the first substantially cylindrical hollow body and the diameter of the second cylindrical support member is significantly less than the diameter of the second substantially cylindrical hollow body.

6. The wind turbine generator claim 2, wherein the wind turbine generator inc lucks a first mounting arrangement for mourning the first cylindrical support member on the first substantially cylindrical hollow body and a second mounting arrangement for mounting the second cylindrical support member on the second substantially cylindrical hollow body.

7. The wind turbine generator of claim 6, wherein at least one of the first and second mounting arrangements comprises a mounting plate.

8. The wind turbine generator of claim 6, wherein at least one of the first and second mounting arrangements comprises a plurality of circumferentially spaced and radially extending spoke members.

9. The wind turbine generator of claim 1, wherein the first substantially cylindrical hollow body includes a first support flange located at the drive end and the second substantially cylindrical hollow body includes a second support flange located at the drive end, the main bearing arrangement acting between the first and second support flanges to mount the rotor for rotation about the stator.

10. The wind turbine generator of claim 9, wherein the main bearing arrangement includes an outer bearing ring which cooperates with the first support flange and at least one inner bearing ring which cooperates with the second support flange.

11. The wind turbine generator of claim 1, wherein the first body has one of a plurality of circumferentially spaced winding slots and a plurality of circumferentially spaced magnet poles formed at its radially inner surface and the second body has the other of the plurality of circumferentially spaced winding slots and the plurality of circumferentially spaced magnet poles formed at its radially outer surface.

12. The wind turbine generator of claim 1, wherein the first body is the stator and the second body is the rotor.

13. The wind turbine generator of claim 1, wherein the first body is the rotor and the second body is the stator.

14. A wind turbine including a wind turbine generator having a drive end at which one or more turbine blades are mountable and a non-drive end, the wind turbine generator comprising:
a first substantially cylindrical hollow body having a radially inner surface;
a second substantially cylindrical hollow body located within the first substantially cylindrical hollow body and haying a radially outer surface;
one of the first substantially cylindrical hollow body and the second substantially cylindrical hollow body being a rotor;
the other of the first substantially cylindrical hollow body and the second substantially cylindrical hollow body being a stator, an air gap being defined between the rotor and the stator;
a main bearing arrangement at the drive end acting between the rotor and the stator to mount the rotor for rotation about the stator;
a stabiliser bearing at the non-drive end acting between the rotor and the stator to stabilise the rotor and stator and maintain the air gap therebetween; and
a hub carrying one or more turbine blades mounted on the rotor at the drive end of wind turbine generator.

15. The wind turbine generator of claim 14, wherein the wind turbine includes a tower on which the wind turbine generator is mounted.
